(19) United States
(12) Patent Application Publication
(10) Pub. No.: US 2017/0242821 A1
(43) Pub. Date: Aug. 24, 2017

(54) ACKNOWLEDGEMENT-LESS CANARY-BASED COMPLETION PROTOCOL

(71) Applicant: HGST Netherlands B.V., Amsterdam (NL)

(72) Inventors: Martin LUEKER-BODEN, San Jose, CA (US); Dejan VUCINIC, San Jose, CA (US)

(73) Assignee: HGST Netherlands B.V.

(21) Appl. No.: 15/049,657

(22) Filed: Feb. 22, 2016

(51) Int. Cl. G06F 15/167; H04L 29/08

(52) U.S. Cl. CPC G06F 15/167; H04L 67/1097

(57) ABSTRACT

A method and system for performing operations in a canary-based communication protocol; specifically, an acknowledgment-less scheme to reduce completion latency and increase effective bandwidth utilization on a computer expansion bus is disclosed. In one embodiment, a host selects a canary to represent whether a data stream of unknown content has been received. The host sends the canary to the target over a communication protocol and then marks a portion of a memory buffer with the same canary. Since the data may be unknown, the canary chosen could be the same value as the data. As such, when processing a request and transmitting data back to the host, the target can do real-time detection to determine whether a canary collision will occur. If a collision does occur, the target can remedy the collision without the need to time out and retry the operation.

### BACKGROUND OF THE DISCLOSURE

Field of the Disclosure

Embodiments of the present disclosure generally relate to methods and systems for performing operations in a canary-based communication protocol.

Description of the Related Art

A communication protocol for a storage media interface specifies how a controller on a storage medium receives commands for processing from a host over an interface. To enable faster adoption and interoperability of storage media connected to a host over a peripheral computer expansion bus, industry participants have defined a communications protocol to include a register programming interface, a command set, and feature set definition.

These communication protocols enable companies and storage manufacturers to write standard drivers for each operating system, and enables interoperability between implementations. Instead of using the central processing unit's (CPU) input/output, which fully occupies the CPU for the entire duration of the read or write operation, the CPU initiates a transfer to a direct memory access (DMA) by putting a request into a queue. The DMA accesses the main systems random access memory (RAM) and performs the operation initiated by ringing a doorbell, notifying the storage device of the request for data, while the CPU does other operations. The storage device fetches the data and communicates back with the DMA. When the transfer is complete, the DMA controller sends an interrupt to the CPU. With slow mechanical hard disk drives, fetching data takes several milliseconds to complete, while the communication protocols take on the order of a microsecond. As such, the communication protocols do not add much to the data fetch/execute cycle time.

However, today a number of different memory technologies exist for storing information for use in a computing system that fetch data within 100 nanoseconds. These different memory technologies may, in general, be split into two major categories: volatile memory and non-volatile memory. Volatile memory may generally refer to types of computer memory that requires power to retain stored data. Non-volatile memory, on the other hand, may generally refer to types of computer memory that do not require power in order to retain stored data. Examples of non-volatile memory may include read-only memory (ROM), magnetoresistive RAM (MRAM), and flash memory, such as NOR and NAND flash, etc. With the improved storage devices reducing the data fetch time to nanoseconds, the microseconds it takes for each communication adds a significant amount of time to the data fetch/execute cycle time.

Therefore, there is a need in the art for an improved communication protocol to reduce the data fetch/execute cycle time.

### SUMMARY OF THE DISCLOSURE

The present disclosure generally is a method and system for performing operations in a canary-based communication protocol; specifically, an acknowledgment-less scheme to reduce completion latency and increase effective bandwidth utilization on a computer expansion bus. In one embodiment, a host selects a canary to represent whether a data stream of unknown content has been received. The host sends the canary to the target over a communication protocol and then marks a portion of a memory buffer with the same canary. Since the data may be unknown, the canary chosen could be the same value as the end of the data. As such, when processing a request and transmitting data back to the host, the target can do real-time detection to determine whether a canary collision will occur. If a collision does occur, the target can remedy the collision without the need to time out and retry the operation.

In one embodiment, a method for performing operations in a communications protocol includes selecting a canary bit string for representing whether a requested data has been received, sending from the host in communication with a target via the communication protocol the canary bit string, marking a portion of a memory buffer with the canary bit string, receiving from the target to the memory buffer via the communications protocol the requested data, where the requested data is a data bit string with previously unknown contents, and having the target determine whether the requested data contains the canary bit string at the end of the data bit string.

In another embodiment, a computer system for performing operations in a communications protocol is disclosed. The computer system for performing operations in a communications protocol includes memory in communication with a host, storage for storing and retrieving data in communication with a target, a target in communication with the host, and a processor in communication with the host, with the memory, with the storage, and with the target. The target transmits the requested data and determines whether the data bit string, which represents the requested data, ends with the canary bit string. If the target does determine that the end of the data bit string matches the canary bit string, the target notifies the processor that the canary bit string matches the requested data, an occurrence hereafter referred to as a canary collision.

In some embodiments the mechanism used to notify the processor of a canary collision may take the form of an interrupt signal passed from the target to the host processor. As is typical of peripheral hardware, the target will post the reason for the interrupt in a dedicated register or pre-determined memory address. Upon examining these interrupt registers the processor will be able to detect the canary collision. If upon examination the processor discovers that a canary collision has occurred, the processor may be instructed to continue its usual data processing program, or it may be instructed to again request data transmission with a new choice of canary. In other embodiments the processor may also transmit a secondary canary bit string to the target in addition to the canary bit string. In such embodiments, the processor marks a portion of the memory region with the canary bit string before transmitting to the target a request for data. If the end of the data bit string representing the requested data matches the canary bit string, then the target marks the same portion of the memory region with the secondary canary bit string, as opposed to the usual contents of the requested data. This modification of the memory region can be detected by the processor, indicating data transmission has been completed, though with some ambiguity remains about the contents of at least some portion of the data bit string. If the processor finds that the memory region has been modified to contain the secondary canary bit string, this may mean that a canary collision has occurred. The data string should match the canary bit string-yet the memory region has been temporarily marked with the secondary canary bit string-or it may mean that the data bit string simply contains the secondary bit string and no modification is necessary. The processor must then query some predetermined register or memory address to determine the true value of ambiguous segment of the data bit string (which may be equal to either the canary or secondary canary bit string.) If needed, the processor makes corrections to the memory region before continuing with its usual programming.

In another embodiment, a non-transitory computer-readable medium, storing instruction that, when executed by a processor, cause a computer system to perform operations in a communication protocol. The processor may perform the steps of selecting a canary bit string (or as needed a primary and secondary pair of canary bit strings) selected to typically differ from the requested data to represent whether a requested data has been received, sending the canary bit strings from the host to the target, marking a portion of a memory buffer with the canary bit string, receiving into the memory buffer a data bit string representing data requested, and having the target determine whether the requested data contains the canary bit string at the end of the data bit string.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 shows a schematic representation of a system implementing a communication protocol, according to one embodiment.

FIG. 2A shows a schematic representation of a message flow of the communications protocol, according to one embodiment.

FIG. 2B shows a schematic representation of a block diagram marking memory buffers in the communications protocol, according to one embodiment.

FIG. 3A shows a schematic representation of a message flow of the communications protocol, according to another embodiment.

FIG. 3B shows a schematic representation of a block diagram marking memory buffers in the communications protocol, according to another embodiment.

FIG. 4 is a schematic flow chart showing a method of performing operations in a communication protocol, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure is a method and system for performing operations in a canary-based communication protocol; specifically, an acknowledgment-less scheme to reduce completion latency and increase effective bandwidth utilization on a computer expansion bus. In one embodiment, a host selects a canary to represent whether a data stream of unknown content has been received. The host sends the canary to the target over a communication protocol and then marks a portion of a memory buffer with the same canary. Since the data may be unknown, the canary chosen could be the same value as the end of the data. As such, when processing a request and transmitting data back to the host, the target can do real-time detection to determine whether a canary collision will occur. If a collision does occur, the target can remedy the collision without the need to time out and retry the operation.

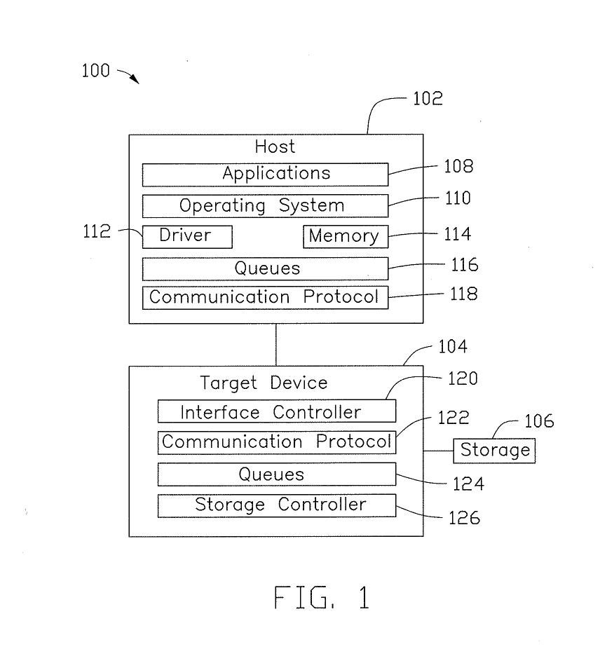

FIG. 1 shows a schematic representation of a system implementing a communication protocol, according to one embodiment. The system 100 includes a host 102 in communication with a target device 104 and storage 106. The host 102 includes user applications 108, operating system 110, driver 112, memory 114, queues 116, and communication protocol 118. The target device 104 includes an interface controller 120, communication protocol 122, queues 124, and storage controller 126 in communication with storage 106.

The host 102 may be a processor such as a central processing unit (CPU). The host 102 can run user-level applications 108 on operating system 110. Operating system 110 can run driver 112 that interfaces with host memory 114. In some embodiments, memory 114 can be dynamic random access memory (DRAM). Host memory 114 can use queues 116 to store commands from host 102 for target device 104 to process. Stored or enqueued commands can include read or write operations from the host 102. Communications protocol 118 can allow host 102 to communicate with target device 104 using interface controller 120. In some embodiments the communication protocol 118 may be transferred over an interface such as peripheral component interconnect express (PCIe), although other packet-based links may be utilized. In another embodiment the communication protocol 118 may be transferred over a transmission control protocol/internet protocol (TCP/IP).

The target device 104 can communicate with host 102 using interface controller 120 and communication protocol 122. Communication protocol 122 can provide queues 124 to access storage 106 via storage controller 126. In some embodiments the target device 104 may be a non-volatile memory such as phase-change memory (PCM), magnetoresistive random access memory (MRAM), resistive random access memory (RRAM or ReRAM), ferroelectric random access memory (F-RAM), or other types of non-volatile memory. In some embodiments of the communication protocol, a target device 104 can poll command queues 116 in host 102 memory 114 substantially, periodically, or continuously, without having to wait for traditional host-driven initiation such as a “doorbell” where the host 102 signals to the target device 104 the availability of a new command to process.

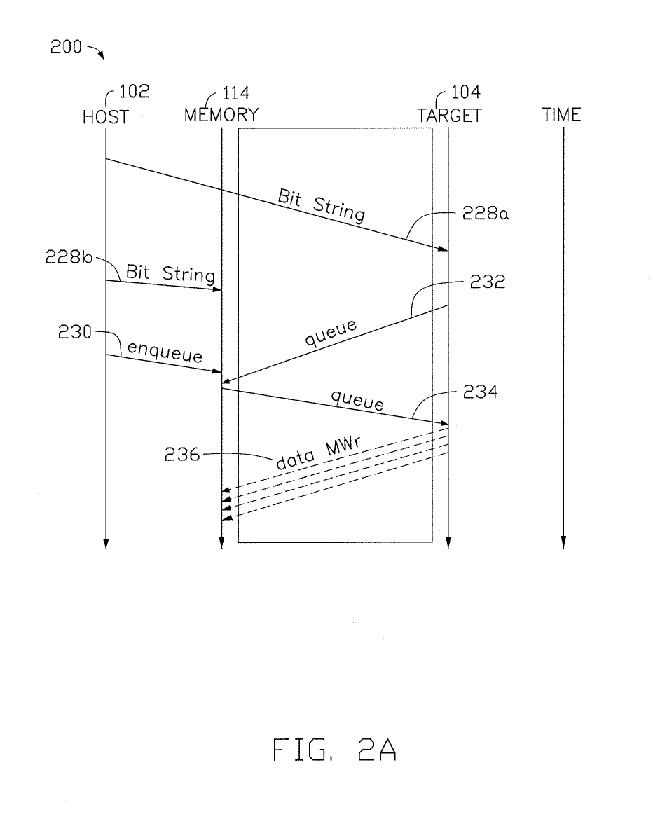

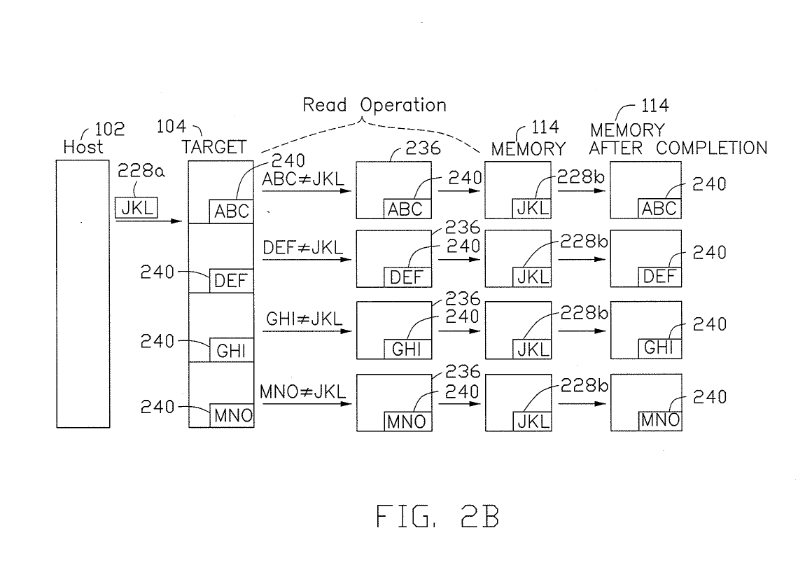

As such, the communication protocol begins with the host 102 selecting a canary bit string. FIG. 2A shows a schematic representation of a message flow of the communications protocol 200, according to one embodiment. It should be understood that the communication protocol 200 can be the same communication protocol 118 in FIG. 1. Time is generally shown flowing down, and the illustrated timing is not to scale. The communication scheme eliminates packets to signal the completion of read requests, thereby reducing completion latency and increasing effective bandwidth utilization on the communication protocol 118 also known as a bus. The host 102 selects the canary bit string. In some embodiments the canary may be a bit string 228a, 228b selected to differ from the end of a larger data 236 block, based on some prior knowledge of the contents of the data. In other embodiments, the canary is a bit string 228a, 228b that may be selected at random. In one embodiment, the bit string is 8 bytes (B) long. In another embodiment, the bit string is longer than 8B.

The host 102 sends the bit string 228a to the target device 104. The host 102 then sends the same bit string 228b to the memory 114. The memory 114 contains portion or buffer that is marked with the bit string 228b. The host 102 can then sends an enqueue 230 command such as a read command to the memory 114. In some embodiments of the communication protocol, the host 102 can send multiple enqueues to the memory 114 at points any time after the bit string 228b was sent from the host 102 to the memory 114. After host 102 enqueues a command such as a read operation, the target device 104 can send a target-initiated command request 232, to request one or more commands in the read queue in memory 114. The host memory 114 can send to the target device 104 the requested queue entry 234. In response to the queue entry 234, the target device 104 can send the requested data 236 to the host memory 114. During the data 236 transfer, the target device 104 compares the bit string 228a to the data 236. In one embodiment, the data 236 is a data bit string longer than 8B and may be for example 512 bytes or more. In one embodiment, during the data 236 transfer, the target device 104 determines whether the data contains the bit string 228a at the end of the data 236.

In one embodiment, the host 102 may enqueue a subsequent command and the target 104 can proceed to initiate a subsequent command request without having to wait for an availability or doorbell signal. Upon receiving the requested queue entry from the host 102, the target 104 can send the requested data to the host memory 114. This process can continue over and over again with multiple distinct commands and responses from the host 102 and the target 104. In some embodiments the above mentioned process can proceed in any order. For example, the host 102 can send multiple enqueues 230 to the memory 114 before the target sends a single command request 232.

FIG. 2B shows a schematic representation of a block diagram marking memory buffers in the communications protocol, according to one embodiment. The host 102 selects the bit string 228a, 228b “JKL.” It should be understood that “JKL” is an example representation of a bit string. The host 102 sends the bit string 228a to the target 104. The host 102 then sends the same bit string 228b to the memory 114. The memory 114 contains portion or buffer that is marked with the bit string 228b. The host 102 can then sends an enqueue 230 command such as a read command to the memory 114. The data 236 in the target 104 contains an end bit sequence 240 “ABC,” “DEF,” “GHI,” and “MNO” respectively. It should be understood that “ABC,” “DEF,” “GHI,” and “MNO” are example representation of an end bit sequence in the larger sequence of the data. As the target 104 transmits the data 236 to the host memory 114, the target compares the bit string 228a to the data 236 and more specifically to the end bit sequence 240. The data 236 is itself a bit string that may be larger than 8B. In one embodiment, the end sequence of the larger data 236 is the end bit sequence 240. If the bit string 228a and the data 236, and more specifically the end bit sequence 240 are different, for example “ABC” “JKL,” the target 104 moves on to process another request. The portion of buffer in the host memory 114 that contains the bit string 228b “JKL” is written over by the data 236, and more specifically the end bit sequence 240 “ABC” for example. The disappearance of the bit string 228b “JKL” from the host memory 114, after being overwritten by the end bit sequence 240, for example “ABC”, is considered the completion signal to the host 102.

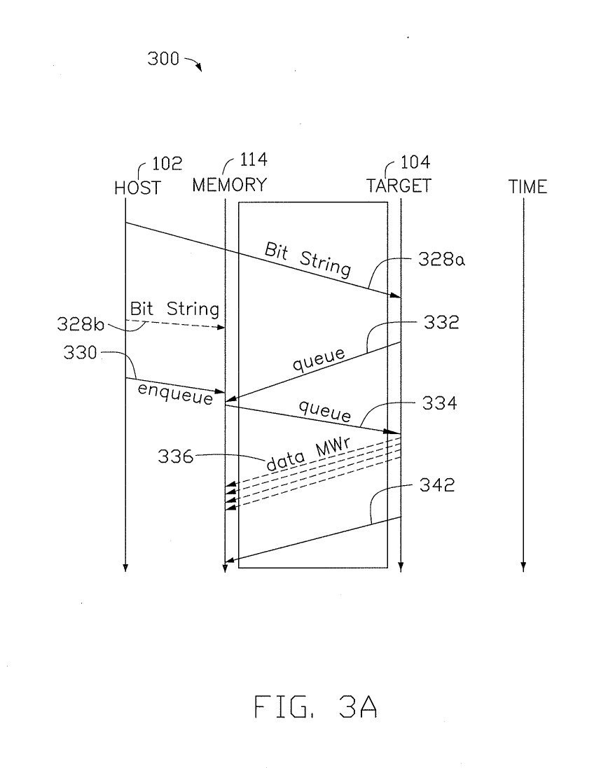

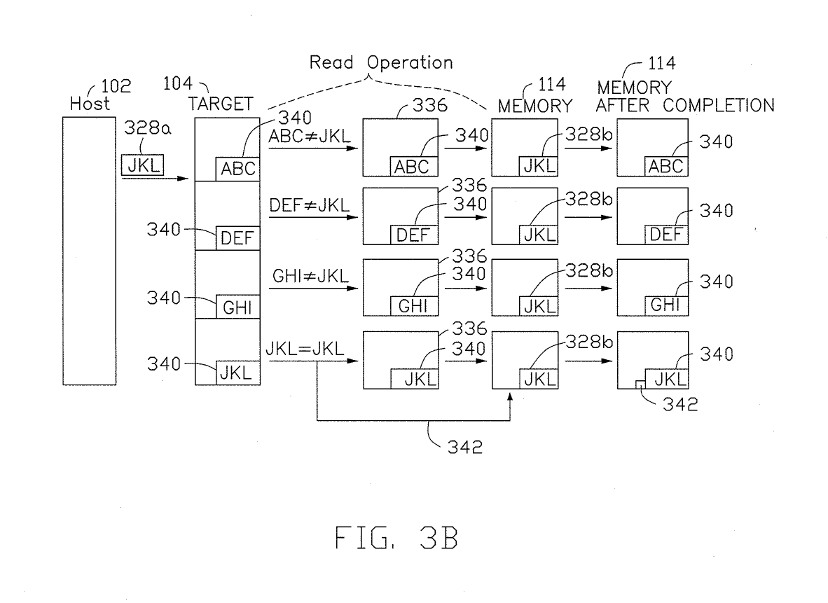

In another embodiment, following the data transfer, the target 104 detects that the bit string and the data are the same and has to take additional steps, as shown in FIG. 3A. FIG. 3A shows a schematic representation of a message flow of the communications protocol 300 where time, illustrated not to scale, is generally shown flowing down. It may be understood that the communication protocol 300 is the same as the communication protocol 118 in FIG. 1. The communication protocol 300 begins with the host 102 selecting the canary. In some embodiments the canary may be a bit string 328a, 328b, selected at random. In one embodiment, the bit string is 8 bytes (B) long. In another embodiment, the bit string is longer than 8B. The host 102 sends the bit string 328a to the target 104. The host 102 then sends the same bit string 328b to the memory 114. The memory 114 contains a portion or buffer that is marked with the bit string 328b. The host 102 sends an enqueue 330 command such as a read command to the memory 114. In some embodiments of the communication protocol, the host 102 can send multiple enqueues to the memory 114 at points any time after the bit string 328b was sent from the host 102 to the memory 114. After host 102 enqueues a command such as a read operation, the target device 104 can send a target-initiated command request 332, to request one or more commands in the read queue in memory 114. The host memory 114 can send to the target 104 the requested queue entry 334. In response to the queue entry 334, the target 104 can send the requested data 336 to the host memory 114. During the data 336 transfer, the target 104 compares the bit string 328a to the data 336. The data 336 is itself a bit string that may be longer than 8B. In one embodiment, the target 104 compares the bit string 328a to the end sequence of the longer data bit string. If the end of the data 336 is the same as the bit string 328a, the target 104 sends the host 102 memory 114 an additional signal 342. In one embodiment, the signal 342 is an interrupt.

In another embodiment, the signal 342 is an exception bit string, written to the end of the memory 114. It should be understood that the exception bit string may be a secondary canary bit string. The interrupt signals to the processor of a high-priority condition. The processor will then send further queries to the host to identify the severity of the problem. If no other errors are identified, the processor may determine that the transaction is complete, and process the data as usual. In some embodiments the processor may choose a new canary bit string 328a, 328b and request retransmission of the data. The exception may be an exception word or sequence that differs from both the canary/bit string and the data. The exception, sent by the target and read by the host, is a previously defined bit string that when recognized triggers an error-checking exchange. In one embodiment, the processor may pick a new canary value and communicate that value to the target peer.

FIG. 3B shows a schematic representation of a block diagram marking memory buffers in the communications protocol, according to one embodiment. The host 102 selects the bit string 328a, 328b “JKL.” It should be understood that “JKL” is an example representation of a bit string. The host 102 sends the bit string 328a to the target 104. The host 102 then sends the same bit string 328b to the memory 114. The memory 114 contains portion or buffer that is marked with the bit string 328b. The host 102 can then sends an enqueue 330 command such as a read command to the memory 114. The data 336 in the target 104 contains an end bit sequence 340 “ABC,” “DEF,” “GHI,” and “JKL” respectively. It should be understood that “ABC,” “DEF,” “GHI,” and “JKL” are example representation of the ending sequence of a larger bit string of the data or end bit sequence. As the target 104 transmits the data 336 to the host memory 114, the target compares the bit string 328a to the data 336 and more specifically to the end bit sequence 340. If the bit string 328a and the data 336, and more specifically the end bit sequence 340 are different, for example “DEF” “JKL”, the target 104 moves on to process another request. If however, the bit string 328a and the data 336, and more specifically the end bit sequence 340 representing the last bytes of the larger data block of bytes are the same, for example “JKL”=“JKL,” the target 104 sends an additional signal 342 to the memory 114. When the data 336, or more specifically the end of the data bit string or end bit sequence 340, is the same as the bit string 328a, this event is termed a canary collision. The bit string 328b “JKL” in the host memory 114 is overwritten by the end bit sequence 340, “JKL”, but the host 102 does not recognize “JKL” as the end bit sequence 340 instead confusing it with the bit string 328b “JKL.” When the end bit sequence 340 “JKL” and the bit string 328b “JKL” are the same, the host 102 does not recognize the data 336 transfer as complete. In the case of a canary collision, conventionally the host would continue to look for the change in the host memory from the canary to the overwritten data. When the host does not find the change, the host would begin the data request again, extending the time further for the data transfer with a line of complex communications.

Embodiments described herein advantageously allow the target to recognize that the host will be confused and remedy the situation by sending an additional signal without the need to time out and retry the operation. While transferring the data 336, the target 104 recognizes that the bit string 328a and the data 336, and more specifically the end bit sequence 340 are the same. At the end of the transfer of data 336, the target 104 sends an additional signal 342 to the host memory 114. In one embodiment, the signal 342 is an interrupt. In another embodiment, the signal 342 is an exception. The interrupt signals to the processor of a high-priority condition. The processor will then complete the transaction. The exception may be an exception word or sequence that differs from both the canary/bit string and the data. The exception, sent by the target and read by the host, is a protocol that when recognized triggers an error-checking exchange. In one embodiment, the processor may pick a new canary value and communicate that value to the target peer.

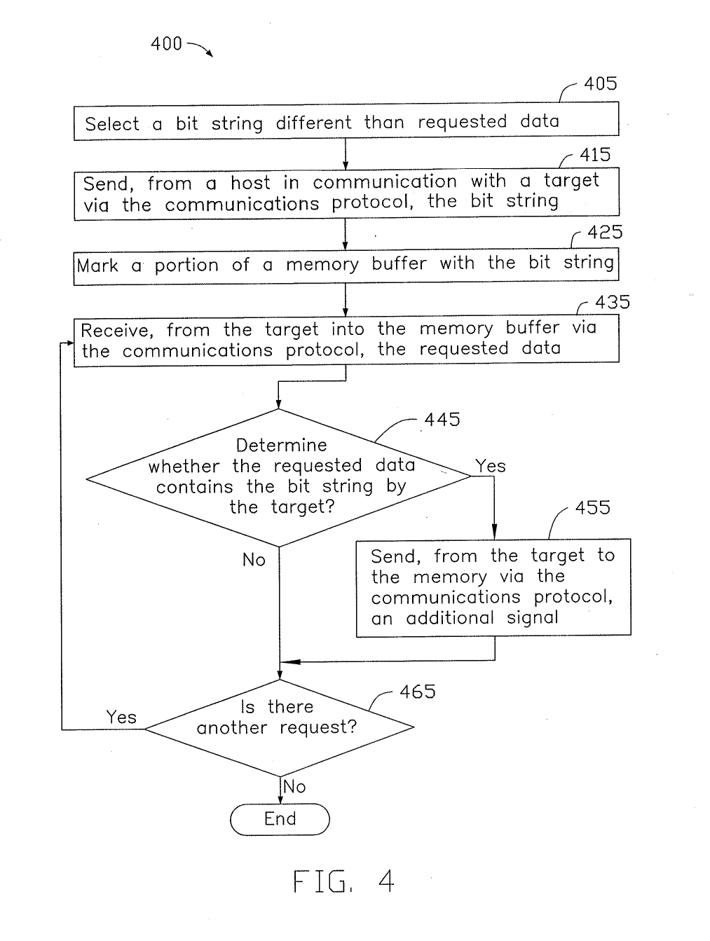

FIG. 4 shows a method 400 of performing operations in a communication protocol, according to one embodiment. The method 400 may be utilized by a system 100 depicted in FIG. 1. At operation 405, the host 102 selects a bit string 228a, 228b, 238a, 238b. In one embodiment, the bit string 228a, 228b, 238a, 238b may be selected to be different than the data 236, 336. In another embodiment the bit string 228a, 228b, 238a, 238b may be selected at random. At operation 415, the host 102 sends the bit string 228a, 238a to the target 104. The host 102 then sends the bit string 228b, 238b to the host memory 114 where at operation 425, a portion of the memory buffer is marked with the bit string 228b, 238b. The host 102 sends an enqueue to the host memory 114 requesting an operation. The host memory 114 is in communication with the target 104 relays the request over an interface. At operation 435, the host memory 114, more specifically the host memory buffer, receives the requested data 236, 336 from the target 104. At operation 445, the target 104 determines whether the requested data 236, 336 contains the bit string 228a, 228b. In one embodiment, the target determines whether the end of the data contains the bit string 228a, 228b. The end of the data may be the ending sequence of a larger bit string of data or end bit sequence or may be understood to be the last bytes of the larger data block of bytes. In one embodiment, the target 104 determines whether the requested data 236, 336 contains the bit string 228a, 328a during the transfer of data 236, 336 over an interface from the target 104 to the memory 114. If the data 236, 336 does contain the bit string 228a, 328a, the target 104 sends the memory 114 an additional signal 342. In one embodiment, the signal 342 is an interrupt. In another embodiment, the signal 342 is an exception. If the data 236, 336 does not contain the bit string 228a, 328a or after the target 104 sends the additional signal 342 to the memory 114, at operation 465, the target 104 can process any additional requests from the host 102.

The presently described communication scheme is especially useful when the data is a priori unknown or random. For example, with use in a network card where the data is unknown and a canary cannot be specifically chosen to differ from the arriving data. As such, the method for performing operations in a canary-based communication protocol described herein reduce completion latency and increase effective bandwidth utilization on a computer expansion bus by processing a request and performing real-time detection to determine whether a canary collision will occur.

While the foregoing is directed to embodiments of the present disclosure, other and further embodiments of the disclosure may be devised without departing from the basic scope thereof, and the scope thereof is determined by the claims that follow.

What is claimed is:

1. A method for performing operations in a communications protocol, the method comprising:
selecting a canary bit string for representing whether a requested data has been received;
sending, from a host in communication with a target via the communications protocol, the canary bit string;
marking a portion of a memory buffer with the canary bit string;
receiving, from the target into the memory buffer via the communications protocol, the requested data, wherein the requested data is a data bit string; and
determining whether the requested data contains the canary bit string at the end of the data bit string, wherein determining whether the data contains the canary bit string is determined by the target.

2. The method of claim 1, wherein determining whether the data contains the canary bit string at the end of the data bit string further comprises if the data contains the canary bit string at the end of the data bit string, sending an exception string from the target to the host, wherein the exception string is different from the canary bit string and the data.

3. The method of claim 1, wherein determining whether the data contains the canary bit string at the end of the data bit string further comprises if the data contains the canary bit string at the end of the data bit string, sending an interrupt from the target to the host, the host clearing the interrupt, and the host resuming processing.

4. The method of claim 1, wherein selecting a canary bit string for representing whether a requested data has been received is selected by the host.

5. The method of claim 1, wherein selecting the canary bit string comprises:
generating a random bit sequence.

6. The method of claim 1, wherein receiving, from the target into the memory buffer via the communications protocol, the requested data, the communications protocol is a doorbell-less communication.

7. The method of claim 1, wherein the canary bit string is selected to differ from the requested data.

8. The method of claim 1, further comprising the host polling the memory buffer for the bit string.

9. The method of claim 1, wherein the host is a central processing unit (CPU).

10. The method of claim 1, wherein the memory buffer is a portion of a memory and wherein the memory is direct random access memory (DRAM).

11. A computer system for performing operations in communications protocol, the system comprising:
memory in communication with a host;
storage, in communication with a target, for storing and retrieving requested data;
a target in communication with the host, for transmitting requested data, the target configured to:
determine whether the requested data contains a canary bit string at the end of a data bit string, wherein the requested data is represented by the data bit string; and
a processor in communication with the host, with the memory, with the storage, and with the target that, when executed by the processor, cause the computer system to:
select the canary bit string for representing whether the requested data has been received;
send, from a host in communication with the target, the canary bit string;
mark a portion of a memory buffer with the canary bit string; and
receive, from the target into the memory buffer, the requested data.

12. The computer system of claim 11, wherein determining whether the data contains the canary bit string at the end of the data bit string further comprises if the data contains the canary bit string, sending an exception string from the target to the host, wherein the exception string is different from the canary bit string and the data.

13. The computer system of claim 11, wherein determining whether the data contains the canary bit string at the end of the data bit string further comprises if the data contains the canary bit string, sending an interrupt from the target to the host, the host clearing the interrupt, and the host resuming processing.

14. The computer system of claim 11, wherein selecting the canary bit string for representing whether a requested data has been received is selected by the host.

15. The computer system of claim 11, wherein selecting the canary bit string comprises:
generating a random bit sequence.

16. A non-transitory computer-readable medium storing instructions that, when executed by a processor, cause a computer system to perform operations in communications protocol, by performing the steps of:
selecting a canary bit string for representing whether a requested data has been received;
sending, from a host in communication with a target via the communications protocol, the canary bit string;
marking a portion of a memory buffer with the canary bit string;
receiving, from the target into the memory buffer via the communications protocol, the requested data, wherein the requested data is a data bit string; and
determining whether the requested data contains the canary bit string at the end of the data bit string, wherein determining whether the data contains the canary bit string is determined by the target.

17. The non-transitory computer-readable medium of claim 16, wherein determining whether the data contains the canary bit string at the end of the data bit string further comprises if the data contains the canary bit string, sending an exception string from the target to the host, wherein the exception string is different from the canary bit string and the data.

18. The non-transitory computer-readable medium of claim 16, wherein determining whether the data contains the canary bit string at the end of the data bit string further comprises if the data contains the canary bit string, sending an interrupt from the target to the host, the host clearing the interrupt, and the host resuming processing.

19. The non-transitory computer-readable medium of claim 16, wherein selecting the canary bit string for representing whether a requested data has been received is selected by the host.

20. The non-transitory computer-readable medium of claim 16, wherein selecting the canary bit string comprises:
generating a random bit sequence.
